(19) United States
(12) Patent Application Publication
(10) Pub. No.: US 2009/0236179 A1
(43) Pub. Date: Sep. 24, 2009

(54) PORTABLE AND MECHANIZED ELEVATED HUNTING STAND

(76) Inventor: Luis Lopez, Houston, TX (US)

Correspondence Address: LAW OFFICE OF DAVID MCEWING, P.O. BOX 231324, HOUSTON, TX, 77023, US

(21) Appl. No.: 12/052,400

(22) Filed: Mar. 20, 2008

(51) Int. Cl. A01M 31/02

(52) U.S. Cl. 182/63.1

(57) ABSTRACT

A portable hunting stand that can be elevated is described. The hunting stand may be trailer mounted for towing to a desired site. The trailer may have multiple jack stands or similar devices to level the trailer on uneven ground. The hunting stand can be raised from ground level without requiring the user to climb steps or a ladder. The hunting stand can use various types of motors or mechanical devices to raise the stand above the ground surface, including hydraulic pumps and motors.

### FIELD OF USE

The specification teaches a hunting stand, e.g., deer hunting stand, that can be used by physically challenged hunters. Hunters within this group may require the use of a wheel chair, have undergone hip or knee replacements otherwise may be unable to climb.

### BACKGROUND TO DISCLOSURE

Some forms of hunting, e.g., deer hunting, utilize an elevated stand. The hunter stands or sits in the elevated position to increase the field of vision for shooting at the hunted animal.

### SUMMARY

The specification teaches a hunting stand including a trailer that can be towed and a height adjustable platform containing a hunting structure. The stand contains a structure that hides the hunter and any movements of the hunter. It also contains apertures that allow the hunter to observe game and shoot a rifle or shotgun. The platform of the structure can be lowered to ground level and elevated by controls housed within the structure. The trailer can include a plurality of height adjustable jack stands. The platform can also include a hinged ramp. The deer stand of may include a power source for raising and lowering the platform. The power source may include a battery, a motor and a pump.

### SUMMARY OF DRAWINGS

The accompanying drawings, which are incorporated by reference and constitute part of the specification, illustrate preferred embodiments of the invention. These drawings, together with the general description of the invention given above and the detailed description of the preferred embodiments given below serve to explain the principles of the invention.

FIG. 1 illustrates a isometric view of the elevated stand showing the relationship of 3 extended jack stands lowered to the ground surface for stability. The viewing or shooting apertures are also shown.

FIG. 2 illustrates the hunting stand lowered to the ground and the rear door and latch. Notice the viewing or shooting apertures are on all four sides of the stand.

FIG. 3 illustrates a front view of the hunting stand including the battery powering the motor and pump to lift and lower the stand.

FIG. 4 illustrates a side perspective of the stand in an elevated position. Two jack stands are attached to each of the two sides of the trailer frame.

FIG. 5 illustrates stand lower to the ground and the rear door open showing the enclosed platform of the hunting stand. It will be appreciated that no climbing is required to gain entry into the stand.

### DETAILED DESCRIPTION OF DISCLOSURE

The disclosure teaches a trailer with wheels for mobility. The trailer includes a hitch device that allows the trailer to be coupled to a truck or similar towing vehicle. When transported, the hunting stand is elevated from the ground. It may be mechanically held in this position.

The trailer has a frame that is connected to the hitch device and components attached to the wheels. In one embodiment, jacks are attached to the frame that can be deployed to a vertical position and that can be extended to the ground surface or elevate the frame of the trailer. In one embodiment, there are four jacks. The bottom of the jack may be extended or returned by turning of a crank. The crank can be turned until the jack is firmly resting upon ground surface. This process can be repeated for each jack until the trailer is resting securely upon the ground. Each jack operates independently of the others. The trailer can thus be leveled on uneven ground. This process provides an easily operable mechanism for a broad and stable base for the elevation of the hunting stand and hunter.

Mounted on the trailer is a hunting stand. The hunting stand and trailer may be painted in camouflage. A hunting stand can be a structure that can be elevated. It can also be lowered from the trailer transport position to the ground level. A hunter walks or wheels himself into the stand, elevates the stand, and awaits the presence of deer. Existing portable deer stands often are lightweight structures that can be assembled and dissembled in the field prior or after use. A common factor of most hunting stands is that the hunter accesses the stand by climbing. The stands can have limited stability. They can have a narrow seat or enclosure.

The disclosure teaches a hunting stand attached to the trailer. The jack stands attached to the trailer frame can stabilize the hunting stand. The stand comprises a platform. The height of the platform can be adjusted. The platform can be lowered so that the platform is level with the ground. In one example, the back edge of the platform is level with the ground. A hunter confined to a wheel chair can roll onto the platform. In addition, a hunter having limited mobility is also able to use the hunting stand. The stand can include a hinged ramp to facilitate the hunter entering the stand. The ramp can be folded up and the door closed.

The hunting stand structure subject of this disclosure can comprise four sides and a roof. The sides of the stand have openings on each side that are dimensioned at a height to allow a sitting hunter to aim is rifle out and shoot at a deer. In one embodiment, the opening for shooting can be dimensioned at a height compatible with the height of a wheel chair.

In another embodiment, the back section of the structure is hinged vertically as a door to gain access to and egress from the stand. In yet another embodiment back section of the structure may be hinged horizontally at the bottom. In this example, when open, the back section forms a ramp structure that allows a wheel chair bound hunter to wheel into the stand. The back section of the structure can be raised to a closed position by a variety of mechanisms, including a rope and pulley. This can be combined with a latching mechanism. It will be appreciated that the hunting stand structure will be constructed of light weight materials.

In another example, one edge may have a hinged ramp that can facilitate the hunter entering the platform. The ramp can then be folded up and the vertically hinged door to the enclosure shut.

The elevation of the hunting stand can be accomplished by several methods. A simple example is a hand powered crank located within the stand that is in communication with hoist, chain and optionally a pulley. The hoist and chain are also attached to the trailer frame.

In another example, the hunting stand is raised and lowered by a combination of a battery, e.g., a 12 volt auto battery powering a motor that in turn powers a hydraulic pump. The pump may power a hydraulic lift cylinder. The motor may have a 3000 pound lifting capacity and the pump can have a 2500 lifting capacity. The hunting stand can be elevated by a cylindrical hydraulic lift. The movement (lengthening or shortening) of the cylinder can move one or more chain link components wherein one end of the chain link component is anchored to the hunting stand and the other end anchored to the trailer support structure. The pump can also turn gears which move a chain link device attached to the hunting stand or the hunting structure mounted on the hunting stand. It will be appreciated that this power configuration will have minimal noise impact and not scare away game animals. Another example uses multiple gears (including a large hand crank) engaged with a toothed rail.

In another example, a cable and winch can be used. The winch can be powered by the battery. The controls for the motor will be located within the hunting structure. A second set of controls may be mounted on the trailer accessible to a person at ground level. Other motorized configurations may be utilized within the scope of the description.

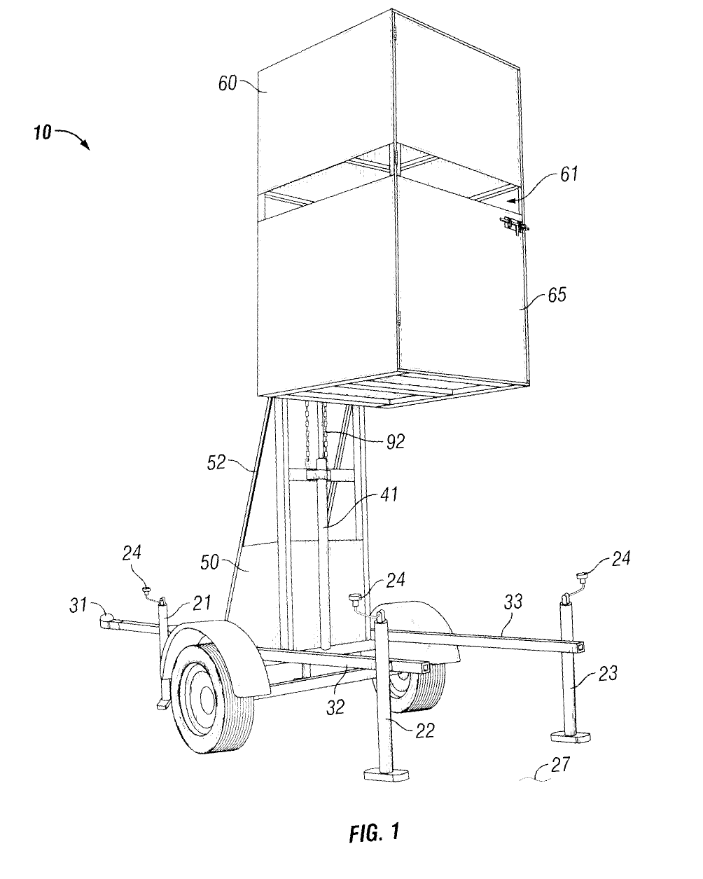

FIG. 1 shows the trailer mounted hunting stand combination 10. Also shown is the back of the trailer with two jacks 22, 23 mounted to the back of the trailer frame 32, 33 and extended to the ground 27. A third jack 21 is shown mounted to the front of the trailer frame. (A fourth jack, also mounted to the trailer frame is not visible.) The cranks 24 for the jacks are also visible. Also shown is the trailer hitch 31.

The equipment/motor bay 50 is illustrated along with an angled reinforcing frame 52. The hydraulic cylinder 41 that raises and lowers the stand is shown. The hunting stand 60 is elevated. The rear facing door 65 is shown along with the viewing/shooting aperture 61.

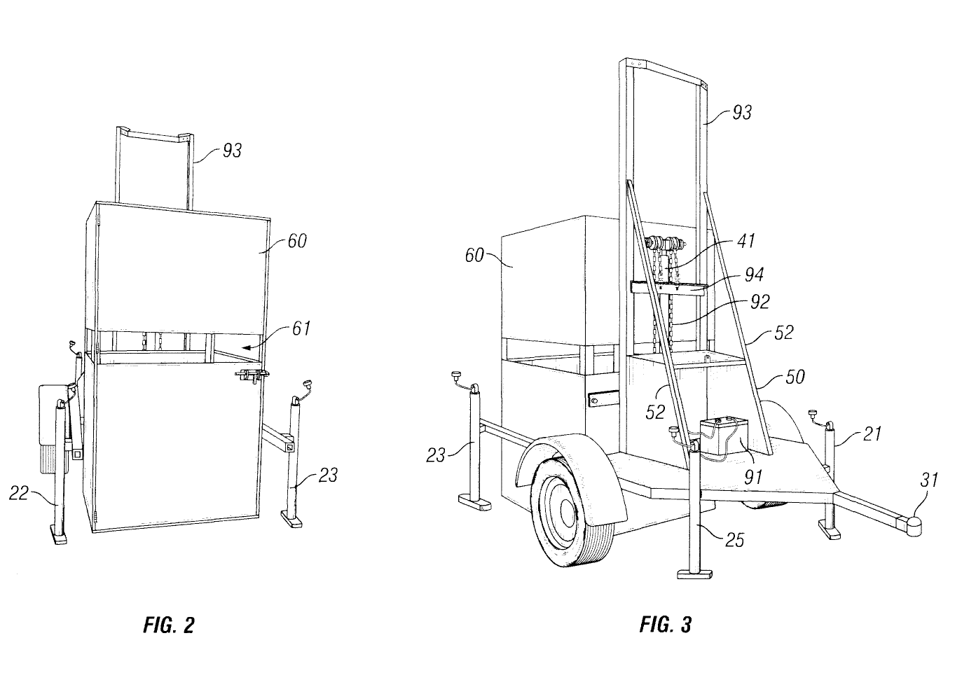

FIG. 2 illustrates the back of the hunting stand 60 lowered to ground level. The viewing/shooting aperture 61 is also shown. One is also illustrated are jack stands 22, 23 and the accompanying jack cranks. The cranks extend and raise each jack relative to the ground surface. According the jacks are raised prior to moving the trailer. Part of the elevating apparatus 93 is shown.

FIG. 3 illustrates the hunting stand showing the hydraulic cylinder lift 41 and the two chain link components 92 that are used to raise and lower the hunting stand 60. The reinforced structure for supporting the elevated hunting structure is also illustrated. The structure is comprised of two angled reinforcing components 52 and two upright components 93. The function of the angled reinforcement includes preventing the main frame from twisting or bending from the load of the hunting stand and occupants. Also shown is a horizontal support 94 to which an end of the chain link component is anchored (the other end being anchored to the hunting stand). The upright components can function as rails or guide tracks for the elevating and descending component controlled by the hydraulic cylinder. Rollers for the cables or chains 92 are attached to the hunting stand.

Also shown in FIG. 3 is the equipment/motor compartment 50. Illustrated is a battery 91. Other components (not shown) may be a motor and hydraulic pump.

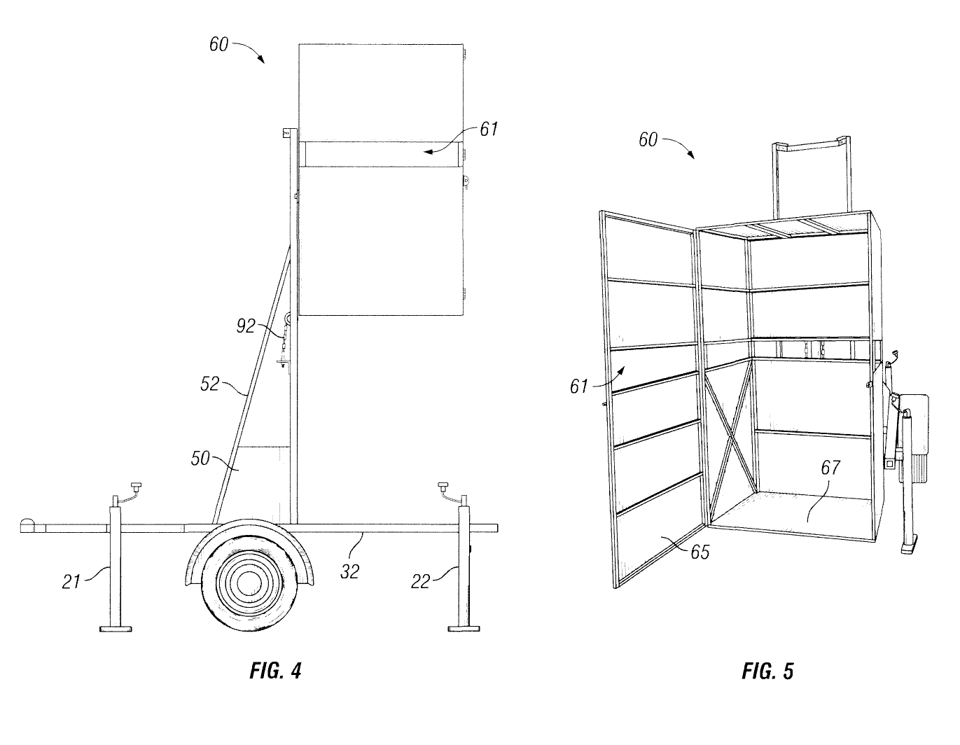

FIG. 4 illustrates a side view of the hunting structure 60 elevated. The extended jack stands 21, 22 are illustrated. The trailer wheels are also illustrated. The observation/shooting aperture 61 for the hunter within the elevated structure are clearly visible. The equipment/motor bay 50, the angled reinforcing component and the raising/lowering chain 92 are also shown. A side of the trailer 32 is also shown.

FIG. 5 illustrates the vertically hinged door 65 of the structure 60 at ground level. It will be appreciated that the platform 67 rests directly on the ground surface to facilitate entry of a wheelchair. Not shown are the controls for adjusting the height of the platform.

The surface area of the platform can vary. In one embodiment, platform is 4 foot by 4 foot. The platform can be made larger to accommodate more than one hunter.

In addition, this specification is to be construed as illustrative only and is for the purpose of teaching those skilled in the art the manner of carrying out the invention. It is to be understood that the forms of the invention herein shown and described are to be taken as the presently preferred embodiments. As already stated, various changes may be made in the shape, size and arrangement of components or adjustments made in the steps of the method without departing from the scope of this invention. For example, equivalent elements may be substituted for those illustrated and described herein and certain features of the invention maybe utilized independently of the use of other features, all as would be apparent to one skilled in the art after having the benefit of this description of the invention.

While specific embodiments have been illustrated and described, numerous modifications are possible without departing from the spirit of the invention, and the scope of protection is only limited by the scope of the accompanying claims.

1. A hunting stand comprising:
a) a trailer; and
b) a variable height platform mounted on the trailer wherein the platform can be lowered to ground level and elevated by controls comprising part of the platform.

2. The hunting stand of claim 1 further comprising a plurality of height adjustable jack stands attached to the trailer frame.

3. The platform of claim 1 further comprising a hinged ramp.

4. The hunting stand of claim 1 further comprising power source for raising and lowering the platform.

5. The hunting stand of claim 4 wherein the power source comprises a battery, a motor, a pump, a hydraulic cylinder and a chain.

6. The power source of claim 5 wherein the battery is a 12 volt battery and the pump has a 2500 pound lift capacity and the motor has 3000 pound lift capacity.

7. The hunting stand of claim 4 further comprising an electric power motor.

8. The hunting stand of claim 4 where the power unit is a hand operated lever and hoist combination with a cable.

9. A wheel chair accessible hunting stand comprising:
a) a trailer mounted platform that can be lowered to the ground surface;
b) an enclosure on the platform further comprising a view/shooting aperture;
c) elevation control within the platform enclosure;
d) a power unit to raise and lower the platform in communication with the elevation controls; and
e) a plurality of trailer stabilizing jacks.

10. The hunting stand of claim 9 further comprising a hinged ramp that can be extended from the platform and the ground

11. The hunting stand of claim 10 further comprising a vertically hinged closure that closes after the hinge ramp is pivoted up.

12. The hunting stand of claim 9 further comprising a trailer housing the power unit to raise and lower the platform.

13. A method of hunting comprising:
a) towing a hunting stand;
b) leveling the trailer with one or more jack stands;
c) lowering the hunting stand to the ground;
d) entering the stand; and
e) elevating the hunting stand.

14. The method of claim 13 further comprising towing the hunting stand wherein the platform is held at the approximate height of the trailer frame.

15. The method of claim 13 further comprising elevating the platform of the hunting stand to approximately 7 to 9 feet.
